(19) United States
(12) Patent Application Publication
(10) Pub. No.: US 2011/0261984 A1
(43) Pub. Date: Oct. 27, 2011

(54) HEARING AID WITH A CASING

(75) Inventor: Monika Bertges REBER, Berne (CH)

(73) Assignee: BERNAFON AG, Berne (CH)

(21) Appl. No.: 13/089,348

(22) Filed: Apr. 19, 2011

Related U.S. Application Data
(60) Provisional application No. 61/326,247, filed on Apr. 21, 2010.

(30) Foreign Application Priority Data
Apr. 21, 2010 (EP) 10160556.6

(51) Int. Cl. H04R 25/00

(52) U.S. Cl. 381/323

(57) ABSTRACT

A hearing aid is provided with a casing where to a battery drawer or lid is movably attached for movement between a closed position and an open position, where the open position grants access to a battery, wherein a leverage tool is removably fastened to the battery drawer. By way of the leverage tool, a hearing aid user with poor dexterity may now easily open the battery drawer.

### BACKGROUND ART

From prior art document US 2004/0062409 a communication system is known comprising a housing adapted for placement behind an ear, the housing comprising a battery compartment which is pivotally mounted in the housing and which has a recess. A communication element, which has a protruding element adapted for engagement with the recess in the battery compartment, is further provided in such a manner that the communication element may be pivoted together with the battery compartment.

Some hearing aid users have very good dexterity and some have very poor dexterity, and it is desired to make a hearing aid which can be customized according to the user's skills in this regard. This will allow all users to manipulate the various mechanical parts of a hearing aid such as battery drawer and on/off levers.

### DISCLOSURE OF INVENTION

A hearing aid is provided with a casing where to a battery drawer or lid is movably attached for movement between a closed position and an open position, where the open position grants access to a battery, wherein a leverage tool is removably fastened to the battery drawer. By way of the leverage tool, a hearing aid user with poor dexterity may now easily open the battery drawer. The leverage tool is removably fastened to the drawer so that hearing aid users without the dexterity problem may use the hearing aid without the tool.

The battery drawer may be hingedly connected to the casing at a pivotal point, and the leverage tool may be fastened to the battery drawer distanced from the pivotal point. Hereby it is ensured, that the leverage provided by the leverage tool will aid the user in performing the pivotal movement which is necessary for opening of the hingedly connected battery drawer.

The leverage tool may comprise a solid body which is shaped to abut along an external surface part of the battery drawer. Preferably a protrusion of the leverage tool extends away from the battery drawer surface in a direction away from the pivot point allowing the user a better grip and enlarged surface for manoeuvring the part

The solid body and the protrusion may together form an L shaped body. One leg of the L may then extend in a radial direction away from the pivot point for increased leverage, where the other leg may abut a surface of the battery drawer for good stability.

An insertion part may be shaped integrally with the L shaped body and may be shaped to fit into a recess in the battery drawer. This allows a very simple and efficient attachment between the leverage tool and the battery drawer.

A hearing aid with a casing may be provided with an on/off switch having a lever at an exterior part of the casing where the lever comprise a protruding part which is to be moved by translation or rotation relative to the hearing aid casing between a first position where the hearing aid is turned on and a second position where the hearing aid is turned off. A leverage tool may be removably fastened to the lever of the on/off switch. This will allow the user with poor dexterity to operate such a lever with ease. The lever may constitute a battery drawer, or the lever may be a dedicated element with no other function than effect switching between off and on.

The leverage tool when fastened at the protruding part may provide an enlarged area of interaction with the hearing aid user, and an enhanced leverage such that the on/off switch may be moved easier and with a smaller force between the first and the second position

### BRIEF DESCRIPTION OF THE DRAWINGS

FIG. 1 shows an example of a hearing aid according to the invention in exploded view,

FIG. 2 is a perspective view of the hearing aid in FIG. 1,

FIG. 3 is a perspective view of the battery drawer and the leverage tool,

FIG. 4 is a detail of a perspective view of the battery drawer with the battery contact springs being shown.

### DESCRIPTION OF AN EMBODIMENT

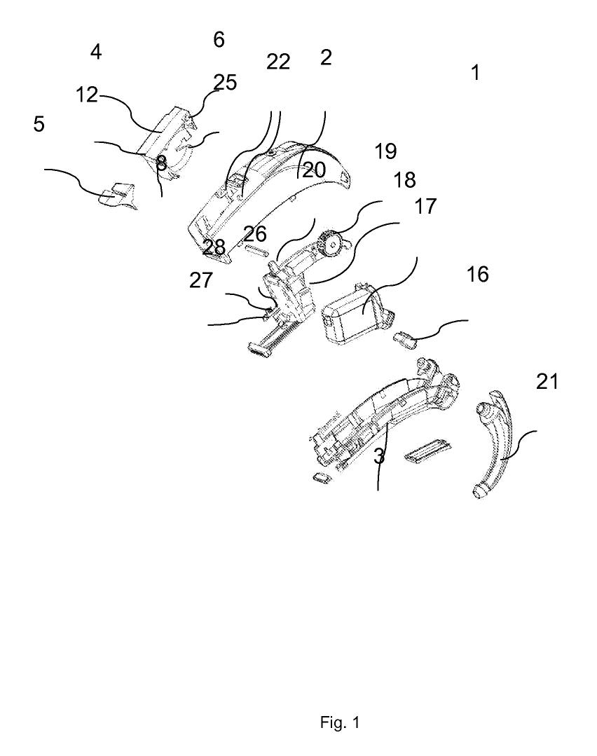

FIG. 1 shows an example of a hearing aid 1 in exploded view. The hearing aid 1 comprise a casing 2,3 which is made from a number of parts, namely an upper part 2 and a lower part 3, such that when the two parts are assembled a protective enclosure results, which will contain the sensitive electronic parts of the hearing aid, such as the microphone 16, the receiver 17, a printed circuit board 18 with various elements thereon. Also a volume control wheel 19 and a shifting button 20 is part of the hearing aid 1, and a hooked sound outlet 21 is also disclosed. Other elements of the hearing aid may be disclosed in the figure, but are not mentioned as they are not essential to the invention. A battery drawer or lid 4 is movably attached to the one casing part 2, for movement between a closed position and an open position, where the open position grants access to the battery (not shown) or battery compartment. To move the battery drawer, a grip area 12 is provided, which allows the user to put pressure onto the drawer for effecting the movement from a closed to an open position. It is wished that the grip area 12 should remain small in order for the hearing aid to stay in-conspicuous, but on the other hand some users, such as elderly people may lack the needed dexterity to operate the battery drawer when the grip area is small.

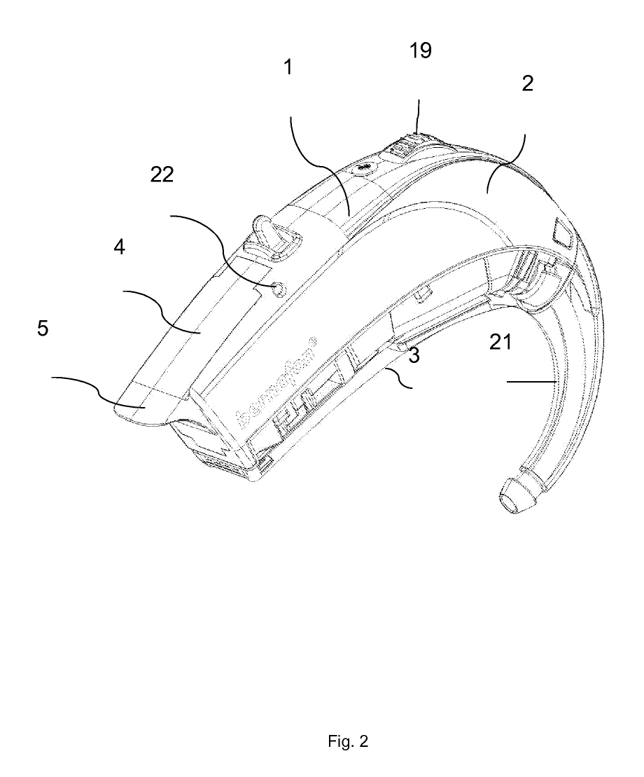

As seen in FIGS. 1 and 2, a leverage tool 5 is attached to the battery drawer 4 at the grip area 12, and this leverage tool 5 will give the user an enlarged area to apply the opening force onto, and thereby facilitate opening of the battery drawer. Preferably the leverage tool 5 is removably fastened to the battery drawer 4, and thereby the leverage tool becomes an optional feature, which the user may choose to have or not to have.

As seen in FIG. 1, the battery drawer 4 is hingedly connected to the casing 2, 3 at a pivotal point 22, 6 and the leverage tool 5 is fastened to the battery drawer 4 distanced from the pivotal point 6, 22. In this way the user will get enhanced leverage around the pivotal point 6, 22 when the battery is opened by use of the leverage tool 5.

The leverage tool 5 is comprised of a solid body shaped to abut along an external surface part 8 of the battery drawer 4. Further, a protrusion 9 is provided, which extends in a direction generally away from the pivot point 22, 6. This construction maximizes the leverage increase of the leverage tool.

Preferably the solid body 7 and the protrusion 9 forms an L shaped body, where the one arm of the “L” abuts the battery drawer 4, and the other arm 9 constitutes the protrusion 9 which extends away from the battery drawer 4.

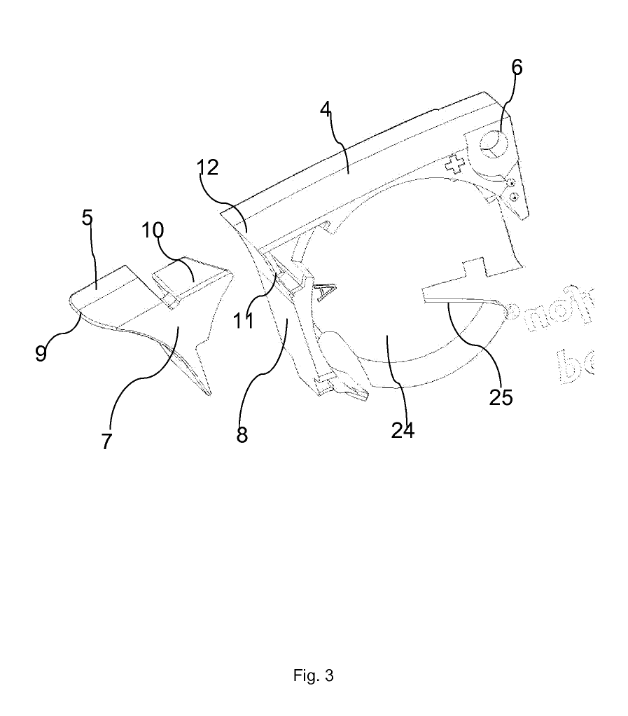

In FIG. 3 an insertion part 10 is seen, which is shaped integrally with the L shaped body of the leverage tool. The insertion part 10 is shaped to fit snugly into a recess 11 in the battery drawer 4. By sliding the insertion part 10 into the recess 11, the insertion part 10 will be placed and firmly held inside the opening formed by the recess 11. Following this, the leverage tool 5 and the battery drawer 4 will move in unison.

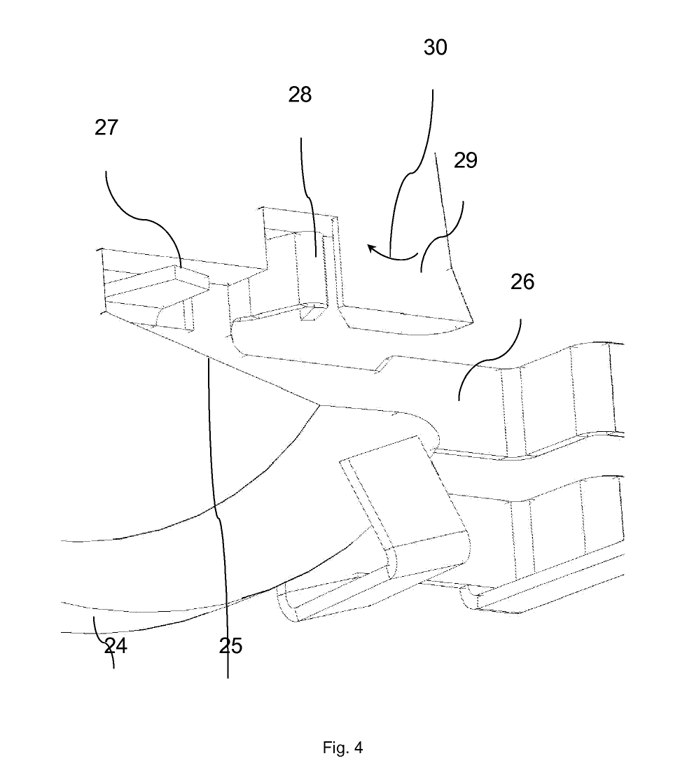

As seen from FIGS. 3 and 4 the battery drawer 4 has a back wall 24 with a cut out portion 25, where through a battery contact spring 26 reaches into the battery chamber and gains electrical contact with the battery surface by way of a contact point 27. A curled portion 28 of the battery spring 26 is provided to interact with a lift part 29 made integral with the back wall 24 and situated adjacent the cut out portion 25. This arrangement will function as an on/off switch which is operated with the battery drawer 1 as a lever. When the battery drawer is pressed from the exterior of the casing for opening movement, the lift part 29 will move in the direction of the arrow 30, and lift the curled portion 28 of the spring 26 in a direction away from the battery surface. This will cause contact point 27 to move similarly as the contact point 27 and the curled portion are part of the same spring element 26. Thus the protruding part 12 of the battery drawer is to be moved by rotation relative to the hearing aid casing between a first position where the hearing aid is turned on and the battery drawer 4 is closed and a second position where the hearing aid is turned off and where the battery drawer 4 is slightly opened. In this position the leverage tool is still locked to the battery door. The leverage tool is removably fastened to the on/off lever provided by the battery drawer, however the drawer needs to open up fully in order to remove the leverage tool from the battery door.

When the leverage tool is fastened at the protruding part, it provides an enlarged area of interaction with the hearing aid user, and an enhanced leverage such that the on/off switch may be moved easier and with a smaller force from the first to the second position.

1. Hearing aid with a casing where to a battery drawer or lid is movably attached for movement between a closed position and an open position, where the open position grants access to a battery, wherein a leverage tool is removably fastened to the battery drawer.

2. Hearing aid as claimed in claim 1, wherein the battery drawer is hingedly connected to the casing at a pivotal point, and where the leverage tool is fastened to the battery drawer distanced from the pivotal point.

3. Hearing aid as claimed in claim 2, wherein the leverage tool comprise a solid body shaped to abut along an external surface part of the battery drawer and a protrusion extending away from the battery drawer surface in a direction away from the pivot point.

4. Hearing aid as claimed in claim 3, wherein the solid body and the protrusion form an L shaped body.

5. Hearing aid as claimed in claim 4, wherein an insertion part is shaped integrally with the L shaped body, and is shaped to fit into a recess the battery drawer.

6. Hearing aid with a casing whereby an on/off switch with a lever at an exterior part of the casing is provided where the lever comprise a protruding part which is to be moved by translation or rotation relative to the hearing aid casing between a first position where the hearing aid is turned on and a second position where the hearing aid is turned off, wherein a leverage tool is removably fastened to the lever the on/off switch.

7. Hearing aid as claimed in claim 6, wherein the leverage tool, when fastened at the protruding part, provides an enlarged area of interaction with the hearing aid user, and an enhanced leverage such that the on/off switch may be moved easier and with a smaller force between the first and the second position.
